(19) United States
(12) Patent Application Publication
(10) Pub. No.: US 2003/0027011 A1
(43) Pub. Date: Feb. 6, 2003

(54) Organic/inorganic multilayer coating system

(76) Inventors: Nicholas Kotov, Stillwater, OK (US); Edward T. Knobbe, Stillwater, OK (US); Olga Kachurina, Stillwater, OK (US); Tammy L. Metroke, Stillwater, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(21) Appl. No.: 10/060,912

(22) Filed: Jan. 29, 2002

Related U.S. Application Data
(60) Provisional application No. 60/264,807, filed on Jan. 29, 2001.

(51) Int. Cl. B32B 7/00

(52) U.S. Cl. 428/594; 428/608; 428/609; 428/614

(57) ABSTRACT

The invention described herein provides an organic-inorganic multilayer coating system comprising an advanced nanostructured layer-by-layer hybrid coating for the corrosion inhibition of metals. Electrochemically-active corrosion inhibitors are adsorbed onto a layer-by-layer assembled organic-inorganic multilayer coating, preferably used in combination with a topcoat sol-gel barrier layer, to provide enhanced corrosion protection of metal substrates.

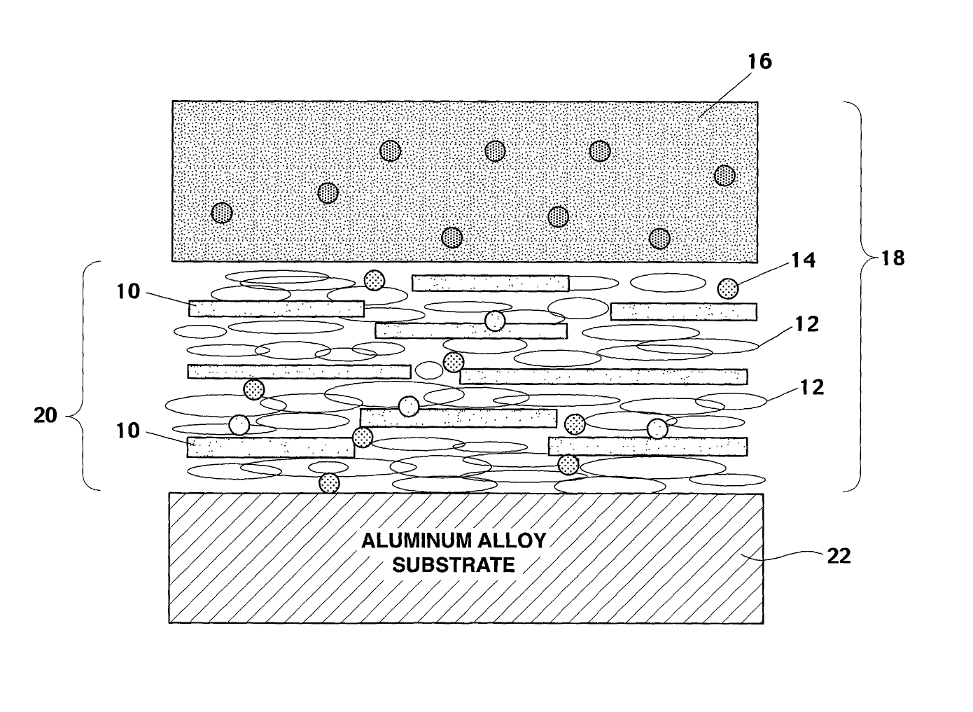

### CROSS REFERENCE TO RELATED APPLICATION

This application claims the benefit of copending U.S. provisional application Serial No. 60/264,807, filed Jan. 29, 2001.

### BACKGROUND OF THE INVENTION

1. Field of the Invention

This invention relates generally to corrosion resistant coatings formed on metal substrates, for example, aluminum alloys, and, more particularly, to a multilayer coating system wherein layer-by-layer hybrid coatings formed of alternating organic/inorganic layers are provided with an active corrosion inhibitor in combination with a sol-gel barrier topcoat.

2. Background

Two strategies have historically been used to obviate the corrosion mechanism in aluminum alloys: (1) barrier coatings and (2) electrochemically-active corrosion inhibitors. Barrier coatings are formed using materials impervious to the penetration or migration of corrosion-inducing species such chloride ions, molecular oxygen, water, and/or free electrons. Electrochemically-active corrosion inhibitors, such as hexavalent chromium compounds, are applied to metal substrates as conversion coatings and impart active corrosion protection, as the corrosion inhibiting ions can migrate on the metal surface, providing self-healing capabilities in the event the integrity of the coating is breached.

Both conventional strategies, however, have recognized drawbacks. On the one hand, barrier coatings degrade in the event of mechanical damage due to the lack of an active corrosion inhibition mechanism. On the other hand, hexavalent chromium compounds are now widely regarded by the EPA as extremely hazardous environmental pollutants. Recently, OSHA has determined that chromate-containing aerosols, such as those generated by large-scale solution spraying, constitute a serious health threat for workers that are exposed to such operations.

In order to eliminate the risk associated with the use of hexavalent chromium compounds, various conversion coatings utilizing alternative active ingredients and mechanisms of protection have been developed as less toxic, environmentally compliant corrosion inhibitors. These systems, for example, have relied on inorganic molecules that react with the oxidized aluminum surface to form mixed oxides, metal ions that are able to oxidize the metal surface during service life, organic polymers with a high complexing capacity for aluminum surfaces, and inorganic film-forming oxides. Recent developments have included rare earth-based conversion coatings, Co-rich oxide layers, Mn-based conversion coatings, Mo-based conversion coatings, Zr-based conversion coatings, silane-based surface treatments, and trivalent chromium conversion coatings. Generally, however, these surface treatments have not been found to exhibit corrosion resistance comparable to the hexavalent chromium based treatments.

### SUMMARY OF THE INVENTION

The invention described herein provides an organic-inorganic multilayer coating system comprising an advanced nanostructured layer-by-layer hybrid coating for the corrosion inhibition of metals. Electrochemically-active corrosion inhibitors are adsorbed onto a layer-by-layer assembled organic-inorganic multilayer coating, preferably used in combination with a topcoat sol-gel barrier layer, to provide enhanced corrosion protection of metal substrates, with potential application in aerospace, aircraft, automobile and construction industries upon, for example, airframe assemblies, automobile frames and construction materials. One advantage of this system is that a less toxic inhibiting ion is capable of providing corrosion protection comparable to that of hexavalent chromium.

The multilayer coating system thus includes at least one each of alternating layers of an organic species and an inorganic species forming a layer-by-layer assembled film, wherein each said layer has an affinity for its adjacent layer(s), and a corrosion inhibitor incorporated into or intercalated among said layers.

The layer-by layer assembly is carried out in a conventional manner upon a substrate by: 1) dipping the substrate in a first aqueous solution of a water-soluble first substance (of a first charge), the first substance possessing an affinity for the substrate; 2) rinsing in neat solvent, such as deionized water, methanol or other suitable compositions free of the substances being applied; 3) dipping in a second aqueous solution of a water-soluble second substance (of an opposite charge than the first substance), the second substance having an affinity for the first substance; and 4) rinsing in neat solvent. These steps are repeated in a cyclic fashion until the desired number of layers has been deposited. As used herein, one substance can be said to have an affinity for another substance via either an electrostatic attraction or by virtue of van der Waals' forces, hydrogen forces or electron exchange.

The organic species may include polyelectrolytes, dyes, polymers, proteins, vesicles, viruses, DNAs, RNAs, oligonucleotides, organic colloids and other organic substances having a molecular weight greater than about 500 atomic units. The inorganic species may include smectite clays, inorganic nanoparticles and other inorganic macromolecular colloids, for example, hydrotalcite, of a similar weight amenable to layer-by-layer assembly. The film may include more than two species, wherein each species layer has an affinity to its adjacent layer(s). The organic and inorganic species, as the case may be, may be either positively or negatively charged, so long as its adjacent layer is of an opposite charge. The film preferably comprises alternating polyelectrolyte-clay layers having ion exchange capacity with an active corrosion inhibitor. Most preferably, the ion-exchanged layer-by-layer film assembly is used in combination with a sol-gel topcoat to provide enhanced corrosion protection.

Also provided is a process for improving the corrosion resistance of metals prone to corrosion by application of the inventive organic-inorganic multilayer coating system.

Thus in one aspect, the present invention provides corrosion protection based on the barrier properties of layer-by-layer film assemblies, wherein interactions between the layers of the film assemblies form a highly dense barrier coating.

In another aspect, the present invention provides corrosion protection based primarily on the ion-exchange properties of the layer-by-layer film assembly. The exchange capacity of the film assembly allows for substitution by an active corrosion inhibitor from an aqueous solution containing the inhibitor. There is thus formed a film assembly having an active corrosion inhibitor incorporated therein.

A better understanding of the present invention, its several aspects, and its advantages will become apparent to those skilled in the art from the following detailed description, taken in conjunction with the attached drawings, wherein there is shown and described the preferred embodiment of the invention, simply by way of illustration of the best mode contemplated for carrying out the invention.

### BRIEF DESCRIPTION OF THE DRAWING

The FIGURE generally illustrates a multilayer clay-polyelectrolyte/sol-gel film corrosion inhibition package in accordance with the most preferred embodiment of the invention.

### DETAILED DESCRIPTION OF THE PREFERRED EMBODIMENT

Before explaining the present invention in detail, it is important to understand that the invention is not limited in its application to the details of the embodiments and steps described herein. The invention is capable of other embodiments and of being practiced or carried out in a variety of ways. It is to be understood that the phraseology and terminology employed herein is for the purpose of description and not of limitation.

Referring first to the FIGURE, the invention is exemplified in a most preferred embodiment wherein alternating inorganic clay sheet layers 10 and organic polymer layers 12 containing active conversion inhibitors 14 are topped with a sol-gel barrier coating 16. Together these components comprise an advanced nanostructured layer-by-layer hybrid coating 18 for the corrosion inhibition of metals.

The preferred layer-by-layer assembled clay-polyelectrolyte film, generally indicated by the reference numeral 20, is prepared by the sequential dipping of the metal substrate 22 into solutions of an aluminosilicate clay material and a polyelectrolyte. The clay exfoliates in water into single aluminosilicate sheets that adsorb onto the surface exclusively in a planar configuration producing densely packed layers. This unique characteristic of layer-by-layer clay films results in pinhole free films with strong adhesion to oxides and exceptional flexibility.

Layer-by-layer assembly (LBL) is a method of thin film deposition often used for oppositely charged polymers or polymers otherwise having affinity. Its simplicity and universality, complemented by the high quality films produced thereby, make the layer-by-layer process an attractive alternative to other thin film deposition techniques. LBL can be applied to a large variety of water-soluble compounds and is especially suitable for the production of stratified thin films in which layers of nanometer thickness are organized in a specific predetermined order.

In accordance with the present invention, a layer-by-layer film is assembled on the substrate material to be protected. Deposition of the film material onto the substrate is performed in a cyclic manner, made possible by the overcompensation of surface charge occurring when alternately charged organic and inorganic layers are adsorbed on a solid-liquid interface. The film is deposited onto a cleaned substrate by repeating the process of: 1) immersion of the substrate in an aqueous solution of an first species, for example, an organic polyelectrolyte; 2) washing with neat solvent; 3) immersion in an aqueous dispersion of a second species, for example, inorganic exfoliated clay sheets; and 4) final washing with neat solvent. This process is repeated as many times as necessary to obtain the number of layers desired. Films produced by this process may be extremely thin, on the order of a few hundred nanometers, but yet of good mechanical strength.

In the preferred embodiment, the first aqueous solution or dispersion of a first substance typically comprises a 0.1-2% (w/v) of an organic polyelectrolyte/polymer. The solution is contacted with the substrate for 1-2 minutes, whereby the affinity between the polyelectrolyte and the substrate results in the adsorption of a layer of polyelectrolyte to the substrate. Weak polyelectrolytes, including but not limited to polyacrylic acid (negatively charged) or poly(dimethyldiallyammonium chloride) (positively charged), are particularly useful due to the existence of a great quantity of easily ionizable groups.

In the most preferred embodiment, the polyelectrolyte is positively charged while the second solution or dispersion of an oppositely charged second substance preferably comprises an aqueous dispersion of exfoliated montmorillonite clay platelets (negatively charged). Such clay platelets have a thickness of about 1.0 nanometer, while extending 150-300 nanometers in the other dimensions. On polyelectrolytes, the clay platelets form a layer of overlapping alumosilicate sheets with an average thickness of 3.8±0.3 nanometers. The relatively large clay platelets are adsorbed virtually parallel to the surface of the substrate, thereby cementing the assembly.

Both rising/washing cycles are typically of a 30 second duration.

Each deposition cycle produces a double layer consisting of a sublayer of organic polyelectrolyte and a monolayer of inorganic colloid. Once deposited, each sublayer serves as a foundation for adsorption of the subsequent, oppositely charged deposit layer.

While the number of layers may be selected to fit particular applications, films of 20-2000 nanometers are preferred, with films of 20 double layers of polyelectrolyte/clay and a thickness of about 100 nanometers being most preferred.

It should be appreciated that different organic polyelectrolytes/polymers can be introduced into the layer-by-layer film stack to optimize ion-exchange capacity, in which case the assembled film may include between the inorganic layers a layer of a second organic polyelectrolyte/polymer of like charge to the inorganic layer.

In order to enhance corrosion resistance characteristics, the layer-by-layer assembled film is immersed in an aqueous solution of a corrosion inhibitor to substitute exchange capacity of the organic and inorganic components with the active inhibitor. As used herein, the term “corrosion inhibitor” encompasses materials which may be incorporated into the LBL film and which provide corrosion protection for the underlying substrate, including (i) uncharged species adsorbed into the film, and (ii) anionic and cationic charged species capable of exchange with either the organic or inorganic layers—including but not limited to molybdates, vanadates, trivalent chromium species, cerium, oxalates, transition metal ions, lanthanide ions, nitrites, cobalt, manganese-based conversion coatings, molybdenum-based conversion coatings, and zirconium based conversion coatings. Though hexavalent chromium is not preferred, it is not excluded from the scope of the present invention.

It is within the skill of one in the art to prepare an aqueous solution of such a corrosion inhibitor of appropriate concentration to effect an ion exchange, allowing for the substitution of active corrosion inhibitors from the aqueous solution containing the inhibiting ion into the film, or to otherwise achieve the incorporation of the corrosion inhibitor into the LBL film, and reference is made in this regard to the patents and publications listed in the appended bibliography, which are hereby incorporated herein by reference.

The assembled film is immersed in such solution for a time period sufficient to effect the substitution. In this manner the corrosion inhibitor is incorporated into the organic and/or inorganic layers. The combination of the corrosion inhibitor and the layer-by-layer assembled film overcomes the limitations of the alternative surface treatments alone to provide an effective substitute for conventional hexavalent chromate conversion coatings.

In another embodiment, the corrosion inhibitor itself, if charged and of the required characteristics, may comprise the inorganic species.

The active corrosion inhibitor may also be incorporated into the preferred topcoat sol-gel layer, to which attention is now directed.

A dense sol-gel barrier layer is preferably applied to the LBL film using either spin, dip or spray application techniques. Dense sol-gel barrier coatings, well known in the art, may be prepared from the acid or base-catalyzed hydrolysis of a variety of alkoxides and organically modified silanes. The sol-gel method consists principally of hydrolysis and condensation reactions originating from alkoxide and/or silane precursors to form a polymeric network. The reaction sequence continues in a manner resulting in the formation of a porous, organically-modified silica network. Simplified chemical reaction sequences and hypothetical hybrid coating structures are indicated below:

(1) Hydrolysis: R-Si(OX)₃+Si(OX)₄+7H₂O→R-Si(OH)₃+Si(OH)₄+7XOH

(2) Condensation: R-Si(OH)₃+Si(OH)₄→R-Si(OH)₂—O—Si(OH)₃+H₂O

wherein, R=vinyl, methacrylate, epoxide, etc., X=alkyl functionality or fragment.

The preferred thickness of such a sol-gel topcoat is 1-100 microns, with 1-25 microns being most preferred.

The present invention will be further understood by reference to the following non-limiting example.

### EXAMPLE

Step 1: Layer-By-Layer Assembly:

Layer-by-layer assembled films of montmorillonite (“Clay”), polyacrylic acid (“PAA”), and poly(dimethyldiallylammonium chloride) (“PDDA”) were prepared by the sequential dipping of a metal substrate into solutions of the polyelectrolytes and an aqueous clay dispersion. The assembly process consisted essentially of a cyclic repetition of four steps: (1) immersion of the substrate into an aqueous 0.1-2% (w/v) solution of the polyelectrolyte for 1-2 minutes, (2) rinsing with ultrapure water for 30 sec., (3) immersion into an aqueous dispersion of clay platelets (concentration of minimal significance), and (4) final rinsing with deionized water for 30 sec. Some films were prepared by alternating PDDA and Clay layers, while other films comprised a combination of PDDA, PAA and Clay layers, wherein the PAA and Clay layers were alternated as the negatively charged species.

Step 2: Absorption of Corrosion Inhibitors:

Test coupons were immersed in 0.25 M K₂Cr₂O₇ for 30 minutes at ambient temperature or into a commercial conversion coating solution developed by Schriever (U.S. Pat. No. 5,551,994) at 140-150° F. for 30 minutes in order to introduce Cr⁶⁺ or Co³⁺ inhibitor ions, respectively. The Schriever conversion coating solution was prepared by mixing 55 g/l NH₄NO₃, 26 g/l Co(NO₃)₂.6H₂O, 26.4 g/l formic acid in 750 ml H₂O. The pH of this solution was adjusted to 7.0-7.1 with concentrated NH₄OH. Subsequently, 3.5 ml/l H₂O₂ (30 wt. %) and distilled H₂O were added to increase the volume to 1 L. The stock solution was heated to 140° F. for 30-90 minutes. The final pH was adjusted to 6.8-7.0 using concentrated NH₄OH. After immersion in the inhibitor solutions, the test coupons were rinsed with deionized water.

Step 3: Application of Sol-Gel Layer:

For purposes of this example, an Ormosil coating was prepared by mixing 5.6 ml tetraethylorthosilicate, 7.6 ml vinyltrimethoxysilane, 2.0 ml 3-(trimethoxysilylpropyl) methacrylate, and 9.8 ml 0.05 M HNO₃. The solutions were allowed to stir for one hour prior to film deposition. The Ormosil solutions were deposited onto cleaned or LBL-coated aluminum alloy substrates by a spray coating technique using an airbrush setup. Ormosil film thicknesses on bare aluminum alloy were approximately 10 microns as measured using a digital DeFelsko Series 6000 coating thickness gage. The coatings were allowed to dry at ambient conditions for at least 24 hours prior to their characterization.

### Electrochemical Results

Potentiodynamic polarization curve analysis of bare aluminum and various LBL/hybrid coating film assemblies are shown in Table 1.

TABLE 1
Summary of Potentiodynamic Polarization Measurements

| | I_{corr} × 10⁷ | R_{corr} | E_{corr} | Eₚᵢₜ |
|---|---|---|---|---|
| Composition | (A/cm²) | (kΩ · cm²) | (mV) | (mV) |
| Aluminum Alloy (AA) 2024- | 31 | 8 | −720 | −654 |
| T3 a | | | | |
| Hexavalent Chromium | 1.74 | 143 | −480 | −439 |
| (Alodine 1200) | | | | |
| AA/PDDA-Clay LBL | 25 | 10 | −561 | −533 |
| (20 Layers) | | | | |
| AA/Sol-Gel | 2.5 | 100 | −510 | −468 |
| AA/PDDA-PAA-Clay LBL | 1.66 | 150 | −473 | −316 |
| (20 Layers)/Sol-Gel | | | | |
| AA/Co³⁺-IE PDDA-PAA-Clay | 1.26 | 199 | −491 | −464 |
| LBL (20 Layers) | | | | |
| AA/Cr⁶⁺-IE PDDA-PAA-Clay | 1.2 | 208 | −484 | −465 |
| LBL (20 Layers) | | | | |
| AA/Co³⁺-IE PDDA-PAA-Clay | 1.25 | 199 | −540 | +342 |
| LBL (20 Layers)/Sol-Gel | | | | |
| AA/Cr⁶⁺-IE PDDA-PAA-Clay | 1.48 | 217 | −200 | +673 |
| LBL (20 Layers)/Sol-Gel | | | | |

a) Aluminum alloy samples were ultrasonically cleaned in acetone prior to electrochemical measurements.

Analysis of Standard Chromate Conversion Coating: Hexavalent chromium conversion coating was used as a control in this study due to its proven ability to act as a corrosion inhibitor for aluminum alloys (AA). Hexavalent chromium conversion coatings on the surface of AA were found to significantly improve the corrosion resistance, R_{corr}, from 8 kΩcm² for bare aluminum to 143 kΩcm² for 2 minute immersion time. Similarly, E_{corr} values were found to shift to the more positive values from −720 mV for bare aluminum to −480 mV for hexavalent chromium conversion coated surfaces.

Analysis of LBL Film Containing No Inhibitor Ions: A significant increase in corrosion resistance was not observed upon coating the AA with 20 layers LBL film. R_{corr} values were found to be 10 kΩcm². However, E_{corr} and Eₚᵢₜ values increased from (−720 to −561) kΩcm² and (−654 to −533) kΩcm², respectively. This shift into the more positive potential region indicates the formation of a thin, barrier film on the substrate.

Analysis of LBL Film, Containing Corrosion Inhibiting Ions: Absorption of either Co³⁺ or Cr⁶⁺ inhibitor ions onto the LBL layers lead to an enhancement in corrosion resistance characteristics. R_{corr} was found to increase from 10 to (199-208) kΩcm²; similarly, E_{corr} and Eₚᵢₜ values were found to increase from −561 mV and −533 mV to (−484 to −491) mV and (−464 to −465) mV, respectively.

Analysis of Sol-Gel Derived Ormosil Film: There is a significant increase in corrosion protection afforded by coating the aluminum alloy with a sol-gel film as indicated by the increase in corrosion resistance, R_{corr}, from 8 kΩcm² for bare aluminum to 100 kΩcm² for AA coated with an Ormosil film. Similarly, an increase in Eₚᵢₜ values from −654 to −468 was observed, respectively.

Analysis of LBL/Sol-Gel Assemblies, Containing no Inhibitor Ions: There is an increase in the corrosion resistance, R_{corr}, from 8 kΩcm² for bare aluminum to 100 kΩcm² for AA/Sol-Gel and to 150 kΩcm² for LBL film/Sol-Gel. These results indicate that the LBL films are highly compatible with the sol-gel coating and provide additional protection when used in combination with the sol-gel coating, compared to the LBL film alone. The same conclusion is inferred from corresponding changes in E_{corr} from −720 mV for bare aluminum to −473 mV for LBL film/Sol-Gel and from −654 mV to −316 mV for Eₚᵢₜ respectively.

Analysis of LBL/Sol-Gel Assemblies Containing Corrosion Inhibiting Ions: Introduction of known active corrosion inhibiting ions using the exchange capacity of clay and PAA in the protective film gives an increase of corrosion resistance, R_{corr}, from 8 kΩcm² for bare aluminum to 199 and 208 kΩcm² for Co³⁺ and Cr⁶⁺, respectively. Introduction of the Ormosil in these systems exhibits a dramatic change of Eₚᵢₜ into the positive potential region. For example, Eₚᵢₜ increased by more than 800 mV for the AA/Co³⁺-exchanged LBL film when compared to the AA/Co³⁺-exchanged LBL film/Sol-Gel, which is also an indication of improved corrosion protection imparted by the complex LBL/Sol-Gel protection system on the AA surface.

It is noteworthy to say that there is no difference in R_{corr}provided by adsorbing Co³⁺ or Cr⁶⁺ ions in the corrosion protective system. This finding indicates the advantage of using a less-toxic inhibiting ion capable of providing corrosion protection comparable to that of hexavalent chromium.

While the invention has been described with a certain degree of particularity, it is understood that the invention is not limited to the embodiment(s) set for herein for purposes of exemplification.

### BIBLIOGRAPHY

Nylund, A., “Chromium-Free Conversion Coatings for Aluminum Surfaces,” Aluminum Transactions, 2, 121 (2000);

Smith, C. J. E., Baldwin, K. R., Garrett, S. A., Gibson, M. C., Hewins, M. A. H., Lane, P. L., “The Development of Chromate-Free Treatments for the Protection of Aerospace Aluminum Alloys,” ATB Metallurgie, 37, 266 (1997);

Puippe, J., “Surface Treatments of Aluminum for Space Applications,” Galvanotechnik., 90, 3003 (1990);

Twite, R. L., and Bierwagen, G. P., “Review of Alternatives to Chromate for Corrosion Protection of Aluminum Aerospace Alloys,” Progress in Organic Coatings, 33, 91 (1998);

Roland, W., Kresse, J., “New Chromium-Free Processes for the Chemical Pretreatment of Aluminum Surfaces,” ATB Metallurgie, 37, 89 (1997);

Hinton, B. R. W., “Corrosion Inhibition with Rare Earth Metal Salts,” J. Alloys Compd. 180, 15 (1992);

Arnott, D. R., Ryan, N.E., Hinton, B. R. W., Sexton, B. A., Hughes, A. E., “XPS Studies of Cerium Corrosion Inhibition on 7075 Aluminum Alloy,” Appl. Surf Sci., 22, 236 (1985);

Morris, E., Stoffer, J. O., O'Keefe, T. J., Yu, P., Lin, X., “Evaluation of Non-Chrome Inhibitors for Corrosion Protection of High-Strength Aluminum Alloys,” Polymeric Materials, 81, 167 (1999);

Ramanathan, L. V., “Corrosion Control with Rare Earths,” Corrosion Prevention & Control, 4, 87 (1998);

U.S. Pat. Nos. 5,551,994 and 5,873,953;

Danilidis, I., Sykes, J. M., Hunter, J. A., Scamans, G. M., “Manganese Based Conversion Treatment,” Surface Engineering, 15, 401 (1999);

Srinivasan, P. B., Sathiyanarayanan, S., Marikkannu, C., Balakrishnan, K., “A Non-Chromate Chemical Conversion Coating for Aluminum Alloys,” Corrosion Prevention & Control, April, 35 (1995);

Rangel, C. M., Simoes, A., Newman, R. C., “The Formation of an Alternative Conversion Coating for Aluminum in Buffered Molybdate Solutions,” Portugalice Electrochimica Acta, 15, 383 (1997);

Schram, T., Goeminne, G., Terryn, H., Vanhoolst, W., Van Espen, P., “Study of the Composition of Zirconium Based Chromium Free Conversion Layers on Aluminum,” Trans. IMF., 73, 91 (1995);

van Ooij, W. J., Zhang, C., Zhang, J. W., Yuan, W., “Pretreatment for Painting by Organofunctional and Non Functional Silanes,” Electrochemical Society Proceedings, 97-41, 222 (1998);

van Ooij, W. J., Song, J., Subramanian, V., “Silane-Based Pretreatments of Aluminum and it Alloys as Chromate Alternatives,” ATB Metallurgie, 37, 137 (1997);

Child, T. F. and van Ooij, W. J., “Application of Silane Technology to Prevent Corrosion of Metals and Improve Paint Adhesion,” Trans. IMF., 77, 64 (1999);

Subramanian, V. and van Ooij, W. J., “Silane Based Metal Pretreatments as Alternatives to Chromating,” Surface Engineering, 15, 168 (1999);

van Ooij, W. J. and Child, T., “Protecting Metals with Silane Coupling Agents,” ChemTech, 28, 26 (1998);

Hinton, B. R., “Corrosion Prevention and Chromates: The End of an Era?” Metal Finishing, 89, 15 (1991); and

Delaunois, F., Poulain, V., Petitjean, J. P., “A Pretreatment Against Localized and Filiform Corrosion Applied to Aluminum Alloys: the Trivalent Chromium Pretreatment,” ATB Metallurgie, 37, 106 (1997).

What is claimed is:

1. An article including a metal substrate having a coating thereon for improving the corrosion resistance of the substrate, the coating comprising:
at least one each of alternating layers of an organic species and an inorganic species forming a layer-by-layer assembled film, wherein each said layer has an affinity for its adjacent layer(s); and
a corrosion inhibitor incorporated into said film.

2. The article according to claim 1, wherein said organic species is selected from the group consisting of polyelectrolytes, dyes, polymers, proteins, vesicles, viruses, DNAs, RNAs, oligonucleotides, and organic colloids having a molecular weight greater than 500 atomic units.

3. The article according to claim 2, wherein said organic species comprises a polyelectrolyte.

4. The article according to claim 3, wherein said polyelectrolyte is poly(dimethyldiallylammonium chloride).

5. The article according to claim 1, wherein said inorganic species is selected from the group consisting of smectite clays, inorganic nanoparticles and other inorganic macromolecular colloids having a molecular weight greater than 500 atomic units.

6. The article according to claim 5, wherein said inorganic species comprises an exfoliated aluminosilicate clay.

7. The article according to claim 6, wherein said exfoliated aluminosilicate clay comprises platelets of montmorillonite.

8. The article according to claim 7, wherein said platelets have a thickness of about 1.0 nanometer, while extending 150-300 nanometers in the other dimensions.

9. The article according to claim 8, wherein said platelets form a layer of overlapping alumosilicate sheets with an average thickness of 3.8±0.3 nanometers.

10. The article according to claim 1, wherein said organic species comprises a polyelectolyte and said inorganic species comprises an exfoliated aluminosilicate clay.

11. The article according to claim 10, wherein the film is of a thickness between 20-2000 nanometers.

12. The article according to claim 11, wherein the film is of a thickness of about 100 nanometers.

13. The article according to claim 1, wherein said corrosion inhibitor is selected from the group consisting of molybdates, vanadates, trivalent chromium species, cerium, oxalates, transition metal ions, lanthanide ions, nitrites, cobalt, manganese-based conversion coatings, molybdenum-based conversion coatings, and zirconium based conversion coatings.

14. The article according to claim 1, wherein said coating further comprises a topcoat layer of a sol-gel material.

15. The article according to claim 14, wherein said topcoat layer of said coating is of a thickness of 1-100 microns.

16. The article according to claim 15, wherein said topcoat layer of said coating is of a thickness of 1-25 microns.

17. The article according to claim 14, wherein said topcoat layer of said coating includes a corrosion inhibitor.

18. The article according to claim 1, wherein the substrate is an aluminum alloy.

19. A process for improving the corrosion resistance of a metal prone to corrosion, comprising:
applying to said metal at least one each of alternating layers of an organic species and an inorganic species forming a layer-by-layer assembled film upon said metal, wherein each said layer has an affinity for its adjacent layer(s); and
immersing said assembled film in a solution or dispersion of a corrosion inhibitor, whereby said corrosion inhibitor is incorporated into said film.

20. The process according to claim 19, wherein said organic species is selected from the group consisting of polyelectrolytes, dyes, polymers, proteins, vesicles, viruses, DNAs, RNAs, oligonucleotides, and organic colloids having a molecular weight greater than 500 atomic units.

21. The process according to claim 20, wherein said organic species comprises a polyelectrolyte.

22. The process according to claim 21, wherein said polyelectrolyte is poly(dimethyldiallylammonium chloride).

23. The process according to claim 19, wherein said inorganic species is selected from the group consisting of smectite clays, inorganic nanoparticles and other inorganic macromolecular colloids having a molecular weight greater than 500 atomic units.

24. The process according to claim 23, wherein said inorganic species comprises an exfoliated aluminosilicate clay.

25. The process according to claim 24, wherein said exfoliated aluminosilicate clay comprises platelets of montmorillonite.

26. The process according to claim 25, wherein said platelets have a thickness of about 1.0 nanometer, while extending 150-300 nanometers in the other dimensions.

27. The process according to claim 26, wherein said platelets form a layer of overlapping alumosilicate sheets with an average thickness of 3.8±0.3 nanometers.

28. The process according to claim 19, wherein said organic species comprises a polyelectolyte and said inorganic species comprises an exfoliated aluminosilicate clay.

29. The process according to claim 28, wherein the film is of a thickness between 20-2000 nanometers.

30. The process according to claim 29, wherein the film is of a thickness of about 100 nanometers.

31. The process according to claim 19, wherein said corrosion inhibitor is selected from the group consisting of molybdates, vanadates, trivalent chromium species, cerium, oxalates, transition metal ions, lanthanide ions, nitrites, cobalt, manganese-based conversion coatings, molybdenum-based conversion coatings, and zirconium based conversion coatings.

32. The process according to claim 19, further comprising applying a topcoat layer of a sol-gel material.

33. The process according to claim 32, wherein said topcoat layer of said coating is of a thickness of 1-100 microns.

34. The process according to claim 33, wherein said topcoat layer of said coating is of a thickness of 1-25 microns.

35. The process according to claim 32, wherein said topcoat layer of said coating includes a corrosion inhibitor.

36. The process according to claim 19, wherein said metal is an aluminum alloy.
